(19) United States
(12) Patent Application Publication
(10) Pub. No.: US 2013/0287051 A1
(43) Pub. Date: Oct. 31, 2013

(54) APPARATUS AND METHOD FOR STABILIZING PULSE OF FIBER-TYPE FEMTOSECOND LASER

(71) Applicant: KOREA ADVANCED INSTITUTE OF SCIENCE AND TECHNOLOGY, Daejeon (KR)

(72) Inventors: Soo Hyun KIM, Daejeon (KR); Kyung-Soo KIM, Seoul (KR); Sung Yoon RYU, Daejeon (KR); Won Sik KWON, Jeonju-si (KR); Hyub LEE, Seoul (KR); Jin Hwan KIM, Siheung-si (KR); Jin Doo CHOI, Seoul (KR); Seung Hwan JO, Daejeon (KR); Sang Wook Lee, Daejeon (KR); Seung Ryeol OH, Daegu (KR)

(73) Assignee: KOREA ADVANCED INSTITUTE OF SCIENCE AND TECHNOLOGY, Daejeon (KR)

(21) Appl. No.: 13/859,089

(22) Filed: Apr. 9, 2013

(30) Foreign Application Priority Data
Apr. 9, 2012 (KR) 10-2012-0036511

(51) Int. Cl. H01S 3/13

(52) U.S. Cl. CPC H01S 3/13
USPC 372/25

(57) ABSTRACT

Provided are an apparatus and method for stabilizing a pulse of a fiber-type femtosecond laser, and more particularly, to an apparatus for stabilizing a pulse of a fiber-type femtosecond laser, which adjusts a distance between a saturable absorption material and an optical fiber connection unit of the femtosecond laser to automatically perform mode-locking, thereby obtaining a laser pulse stabilized for a long time, and a method for stabilizing the pulse of the fiber-type femtosecond laser. The apparatus for stabilizing a pulse of a fiber-type femtosecond laser in a fiber-type femtosecond laser system including a pump laser (100) and a fiber cavity (200) includes a distance adjustment part (300) adjusting a distance (d) between a saturable absorption material (700) and a connection unit of an optical fiber (310) which are provided within the fiber cavity (200).

### CROSS-REFERENCE TO RELATED APPLICATIONS

This application claims the priority of Korean Patent Application No. 10-2012-0036511 filed on Apr. 9, 2012, in the Korean Intellectual Property Office, the disclosure of which is incorporated herein by reference.

### BACKGROUND OF THE INVENTION

1. Field of the Invention

The present invention relates to an apparatus and method for stabilizing a pulse of a fiber-type femtosecond laser, and more particularly, to an apparatus for stabilizing a pulse of a fiber-type femtosecond laser, which adjusts a distance between a saturable absorption material and an optical fiber connection unit of the femtosecond laser to automatically perform mode-locking, thereby obtaining a laser pulse stabilized for a long time, and a method for stabilizing the pulse of the fiber-type femtosecond laser.

2. Description of the Related Art

Ultra-precision processing using a laser is getting the spotlight in principal industrial fields that lead economic growth of our country such as semiconductor fields, next-generation display fields, LED fields, solar cells fields, and the like. However, micro processing using an existing laser has a limitation in which heat is generated by interaction between a laser beam and a material. Thus, processing technologies using an ultrashort femtosecond laser are being developed since the year 1990. Ultrashort femtosecond laser processing technologies as specific heat ultra-precision green processing technologies may have advantages that allow of ultra-precision shape processing and repairing to form ultra-precision shapes in a transparent material as well as on a surface of a material. Thus, as their application fields are being expanded, ultrashort femtosecond laser processing technologies are being put to use in various fields such as semiconductor industry fields, orthoptic and bio-therapeutic fields, two-photon absorption-based three-dimensional shape processing fields, photonic crystal processing fields, and the like.

Ultrashort femtosecond laser processing technologies have convenience in use due to miniaturization of a femtosecond fiber laser on the basis of its advantage. Interest in development of the miniaturized femtosecond fiber laser and application of the femtosecond fiber laser as portable devices in an outdoor environment is greatly increasing. Paradoxically, there is a growing need for a femtosecond laser that can resist disturbance and be stabilized for a long time. Femtosecond fiber lasers may be utilized as portable devices in portable sensors, remote sensors, absolute distance measuring devices, terahertz oscillators, and the like.

Typical ultrashort femtosecond optical pulse may be generated through a method such as gain switching, Q-switching, photoelectric feedback, self-oscillating laser, or mode-locking. The mode-locking method is being mainly used for generating an ultrashort optical pulse having high coherence in industries.

In general, a laser oscillator is constituted by a cavity and a gain medium. An amplification band of the gain medium that corresponds to an optical amplifier and a length of the cavity may be changed to allow a laser to operate in a single mode or resonance mode. An ultrashort femtosecond laser has about 100,100 resonance modes to about 1,000,000 resonance modes. Also, the ultrashort femtosecond laser may cause interference compensation in a constant moment at which phases match each other according to a change of the surrounding environment to generate ultrashort pulses.

The mode-locking may be classified into active mode-locking and passive mode-locking according to whether an external modulating signal is applied. In general, since the passive mode-locking generates a pulse shorter than that of the active mode-locking, the passive mode-locking is widely used for an ultrashort pulse laser.

A saturable absorption material is an optical medium that is inserted into a cavity to realize the passive mode-locking. A semiconductor saturable absorber mirror (SESAM) is widely used as the saturable absorption material. In addition, to compensate a limitation that is impossible to change a mode-lockable wavelength band, researches with respect to development of a saturable absorption material using carbon nanotubes (CNT) or graphene are actively carried out.

Among the related arts with respect to femtosecond lasers, there are successful researches with respect to fiber lasers which perform passive mode-locking by using a CNT saturable absorption material to generate short pulses. For example, in a case of US Patent Publication No. 2010/0296527A1 (“Passively Modelocked Fiber Laser Using Carbon Nanotubes”), a pulse repetition rate may be adjustable according to a cavity length. The related arts disclose a method in which a cavity length is passively adjusted to generate a pulse having a desired repetition rate in a range of about 315 MHz to about 415 MHz that is intended initially.

Also, referring to a thesis (“Stabilization of Frequency of Femtosecond Laser for Measuring Distance and Shape” co-authored by Young-jin Kim, Dong-han Jin, and Seung-woo Kim) submitted by Young-jin Kim in 2005, it is seen that a system for stabilizing a repetition rate of a pulse laser uses a principle similar to that of the above-described US Publication Patent. In the related arts, a PZT that is movable in a piston direction may be mounted on an output coupler mirror, and a PZT that is movable in an inclination direction may be mounted on a mirror opposite to a cavity to control a repetition rate and an option frequency.

When a fiber-type femtosecond laser using a saturable absorption material is manufactured, an optimum distance for mode-locking between the saturable absorption material and an optical fiber exists. If a distance between the saturable absorption material and the optical fiber in optimal mode-locking is dm, in a case of d>>dm, i.e., in a case where a distance d between the saturable absorption material and the optical fiber is significantly greater than that between the saturable absorption material and the optical fiber in mode-locking, since the whole cavities are opened, laser oscillation does not occur. However, when the value d approaches the value dm, light emitted from one side of the optical fiber passes through the saturable absorption material and then is incident again into the other side of the optical fiber to close the whole cavities. Then, when a light emitting spectrum in a wavelength band of about 1,550 nm is measured, and then the d value is equal to the dm value, pulses may be oscillated. As the value d is gradually less than the value dm, the mode-locked state may be unstably changed to cause unstable pulses. Also, when the distance gradually decreases, the pulses may be broken finally.

However, in the related art described above, since the distance is optimally set when the laser is initially manufactured, the laser has a pulse dynamic characteristic of a desired level. However, as a time elapses, the laser does not respond to a change of the external environment. In the case of the fiber-type femtosecond laser, a distance between a saturable absorption material and an optical fiber with respect to a specific power of a pump laser is fixed to in an optimum state. Also, when the femtosecond laser operates, mode-locking may be just performed. However, when the power of the pump laser is adjusted, or the femtosecond laser operates for a long time, heat may be generated, or an optical characteristic of the saturable absorption material may be changed due to oxidation to change the initially set optimum distance. Thus, when the laser operates for a long time, a pulse dynamic characteristic may be changed to cause unstable pulses. Also, as the distance between the saturable absorption material and an optical fiber connector may be minutely changed by various mechanical oscillation elements, unstable pulses may be generated.

### PRIOR ART DOCUMENTS

### Patent Documents

(Patent Document 1) US Patent Publication No. 2010/0296527A1 (“Passively Modelocked Fiber Laser Using Carbon Nanotubes”)

### Non-Patent Documents

(Non-patent Document 1) Thesis: “Stabilization of Frequency of Femtosecond Laser for Measuring Distance and Shape”, Young-jin Kim, Dong-han Jin, and Seung-woo Kim, in 2005

### SUMMARY OF THE INVENTION

An aspect of the present invention provides an apparatus and method for stabilizing a pulse of a fiber-type femtosecond laser, which automatically stabilize the pulse in response to various actual external environment variations to manufacture and utilize a laser system that automatically performs mode-locking even though the optical pulse is unstable and resists external oscillation or the external environment variations.

According to an aspect of the present invention, there is provided an apparatus for stabilizing a pulse of a fiber-type femtosecond laser in a fiber-type femtosecond laser system including a pump laser 100 and a fiber cavity 200, the apparatus including a distance adjustment part 300 adjusting a distance d between a saturable absorption material 700 and a connection unit of an optical fiber 310 which are provided within the fiber cavity 200.

The distance adjustment part 300 may include: a base 360; a first optical fiber 310; a second optical fiber 320 that mounts the saturable absorption material 700; a moving unit 360 supporting the first optical fiber 310 and relatively movable with respect to the base 360 to adjust a distance d between the first optical fiber 310 and the saturable absorption material 700 mounted on the second optical fiber 320; and a driving unit 340 relatively moving the moving unit 330.

The distance adjustment part 300 may include: a coupler 400 branching a laser pulse from a main line to perform a feedback control for stabilizing a laser pulse; a detection unit 500 for extracting control monitoring variables of the branched laser pulse; and a driving control unit 600 substantially adjusting the distance d between the saturable absorption material 700 and the connection unit of the optical fiber 310 on the basis of the control monitoring variables.

The distance adjustment part 300 may further include a display unit 800 allowing a user of the laser system to monitor a distance adjustment state between the saturable absorption material 700 and the connection unit of the optical fiber 310.

A fixing unit 350 maintaining the second optical fiber 320 may be supported on the base 360, the saturable absorption material 700 may be supported on an end of the second optical fiber 320 to face the first optical fiber 310, the first optical fiber 310 may be horizontally movably supported by the moving part 330 at a relative position of the second optical fiber 320 above the base 360 to face the second optical fiber 320, and the first optical fiber 310 may relatively move with respect to the base 360 as the moving unit 330 of the first optical fiber 310 horizontally moves to change the distance d between the saturable absorption material 700 attached to the end of the second optical fiber 320 and the first optical fiber 310.

The driving unit 340 that is capable of relatively horizontally moving the moving unit 330 supporting the first optical fiber 310 may be disposed on the base 360, and the driving unit 340 may be connected to a driving control unit 600 and controlled by the driving control unit 600.

The detection unit 500 may be selected from a spectroscope, a PD, and a power meter as an optical detection device used for detecting light.

The detection unit 500 may detect at least one of variations of a spectrum, an intensity of a signal, and a repetition rate as output signals.

The detection unit 500 may include the spectroscope to monitor a peak wavelength value of the laser pulse, a half width at half maximum in a wavelength, and a shape of a spectrum.

The detection unit 500 may include the PD to monitor an intensity and frequency of an output signal.

The driving control unit 600 may include a storage unit that stores the monitoring variables in a state where the laser pulse is stable.

According to another aspect of the present invention, there is provided an apparatus for stabilizing a pulse of a fiber-type femtosecond laser in a fiber-type femtosecond laser system including a pump laser 100 and a fiber cavity 200 and using a reflective-type saturable absorption material 700, the apparatus including a distance adjustment part 300 adjusting a distance d between the saturable absorption material 700 and a reflective plane mirror 370 which are provided within the fiber cavity 200.

The distance adjustment part 300 may include: a base 360; a first optical fiber 310 that mounts the saturable absorption material 700; the plane mirror 370 disposed on the base 360 to face the saturable absorption material 700; a moving unit 360 supporting the first optical fiber 310 and relatively movable with respect to the base 360 to adjust a distance d between the plane mirror 370 and the saturable absorption material 700 mounted on the first optical fiber 320; and a driving unit 340 relatively moving the moving unit 330.

The distance adjustment part 300 may include: a coupler 400 branching a laser pulse from a main line to perform a feedback control for stabilizing a laser pulse; a detection unit 500 for extracting control monitoring variables of the branched laser pulse; and a driving control unit 600 substantially adjusting the distance d between the saturable absorption material 700 and the plane mirror 370 on the basis of the control monitoring variables.

The distance adjustment part 300 may further include a display unit 800 allowing a user of the laser system to monitor a distance adjustment state between the saturable absorption material 700 and the plane mirror 370.

A device for driving a piezo 390 may be used as the driving unit 340 adopted for the distance adjustment part 300.

The piezo 390 may include a driving shaft 380 and is supported on the base 390 to rotate the driving shaft 380, thereby horizontally moving the moving unit 330.

According to another aspect of the present invention, there is provided a method for stabilizing a pulse of a fiber-type femtosecond laser, the method including: a first step S100 of allowing a user of a laser system to apply a power to the laser system to utilize the laser system according to purpose of the laser system; a second step S200 of connecting a coupler 400 to a main line to split a pulse signal in real-time, thereby transmitting the split pulse signal into a detection unit 500; a third step S300 of receiving the pulse signal into the detection unit 500 from the coupler 400 to extract monitoring variables for adjusting a distance between a saturable absorption material 700 and an optical fiber 310 or a distance between the saturable absorption material 700 or a plane mirror 370; a fourth step S400 of determining whether the laser pulse signal is unstable through a driving control unit 600 by using the monitoring variables; a fifth step S500 of determining whether the laser pulse signal is unstable as the distance between the saturable absorption material 700 and the optical fiber 310 or the plane mirror 370 is widened or as the distance between the saturable absorption material 700 and the optical fiber 310 or the plane mirror 370 is narrowed; a sixth step S600 of adjusting the distance between the saturable absorption material 700 and the optical fiber 310 or the distance between the saturable absorption material 700 or the plane mirror 370 according to the result of the fifth step S500.

In the third step S300, the detection unit 500 may extract at least one of a peak wavelength value of a spectrum, a half width at half maximum, and a shape of the spectrum as the monitoring variables.

The fifth step S500 may include a step of determining whether the laser pulse signal is unstable by using the monitoring variables previously stored in a stable state.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a conceptual view illustrating an apparatus for stabilizing a pulse of a fiber-type femtosecond laser according to the present invention;

FIG. 2 is a graph illustrating a laser pulse spectrum in a stable state according to the present invention;

FIG. 3 is a graph illustrating a laser pulse spectrum in a state where a distance between a saturable absorption material and an optical fiber connection unit is gaped;

FIG. 4 is a graph illustrating a laser pulse spectrum in a state where the distance between the saturable absorption material and the optical fiber connection unit is narrowed;

FIG. 5 is a conceptual view of a reflective-type saturable absorption material laser system according to another embodiment of the present invention;

FIG. 6 is a concept view of an apparatus for stabilizing a pulse to which a piezo is adopted according to further another embodiment of the present invention; and

FIG. 7 is a flowchart for explaining a method for stabilizing a pulse of the fiber-type femtosecond laser according to the present invention.

### DETAILED DESCRIPTION OF THE PREFERRED EMBODIMENT

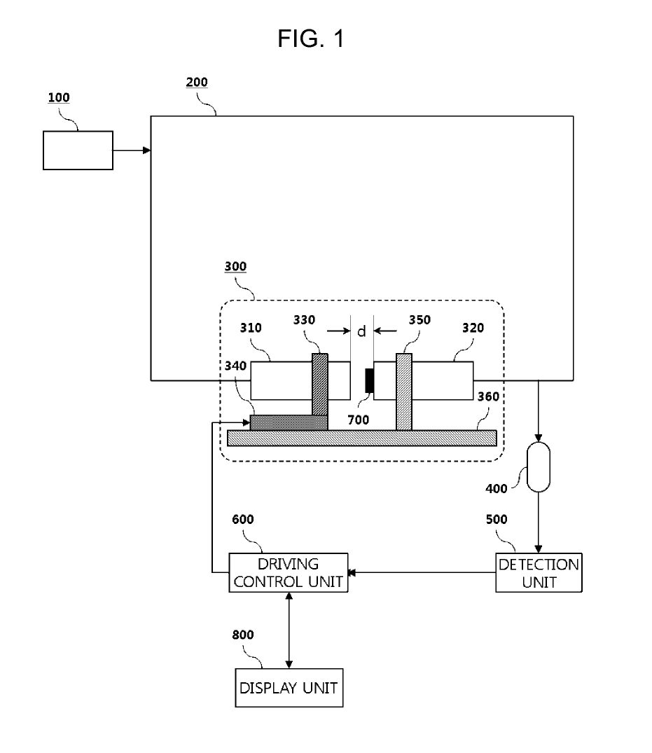

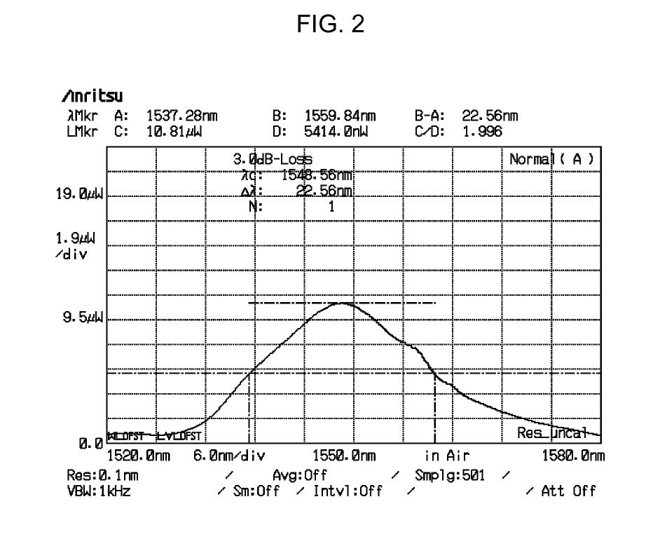

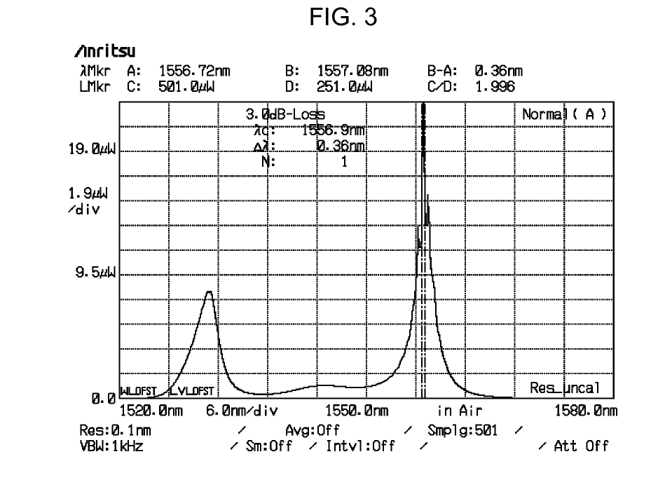

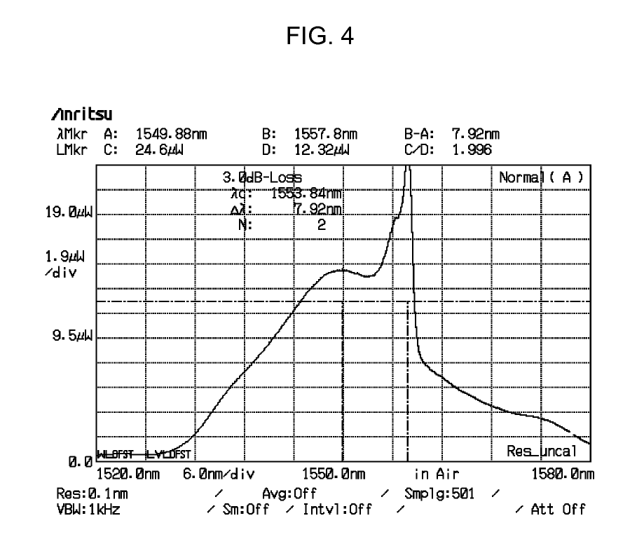

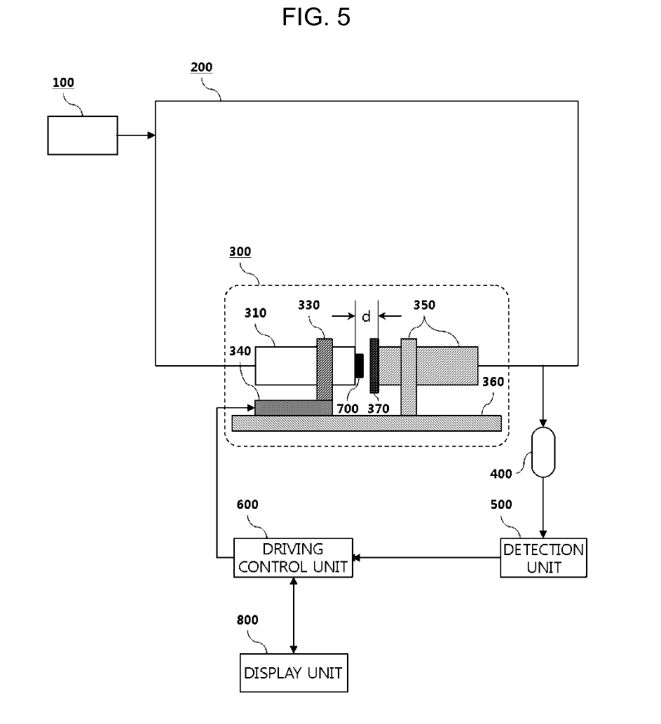

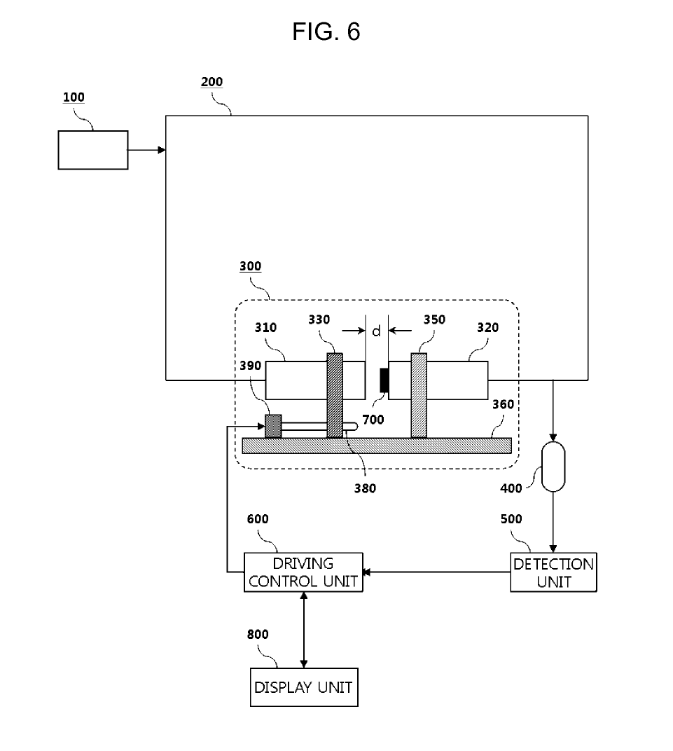

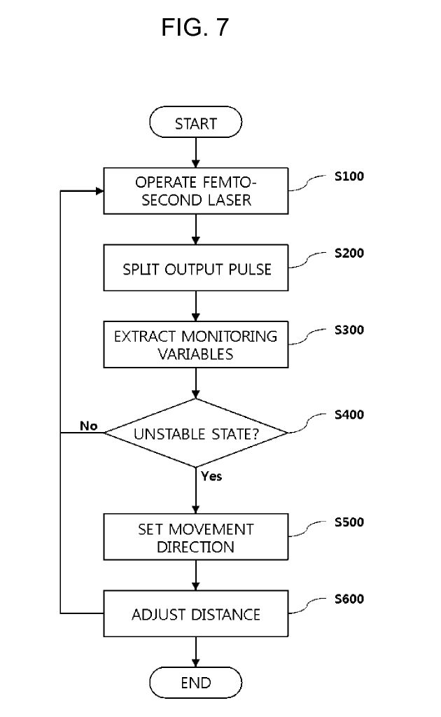

Exemplary embodiments of the present invention will be described below in more detail with reference to the accompanying drawings. FIG. 1 is a concept view illustrating an apparatus for stabilizing a pulse of a fiber-type femtosecond laser according to the present invention. FIG. 2 is a graph illustrating a laser pulse spectrum in a stable state according to the present invention, FIG. 3 is a graph illustrating a laser pulse spectrum in a state where a distance between a saturable absorption material and an optical fiber connection unit is gaped, and FIG. 4 is a graph illustrating a laser pulse spectrum in a state where the distance between the saturable absorption material and the optical fiber connection unit is narrowed. FIG. 5 is a concept view of a reflective-type saturable absorption material laser system according to another embodiment of the present invention, and FIG. 6 is a concept view of an apparatus for stabilizing a pulse to which a piezo is adopted according to further another embodiment of the present invention. FIG. 7 is a flowchart for explaining a method for stabilizing a pulse of the fiber-type femtosecond laser according to the present invention.

Although unnecessary details that are not different from those according to a related art in the understanding of technical ideas are excluded, the technical spirit and scope of the present invention are not limited thereto.

First, an apparatus for stabilizing a pulse of a fiber-type femtosecond laser according to the present invention will be described with reference to FIG. 1.

The apparatus for stabilizing the pulse of the fiber-type femtosecond laser according to the present invention in a fiber-type femtosecond laser system including a pump laser 100 and a fiber cavity 200 includes a distance adjustment part 300 for adjusting a distance d between a saturable absorption material 700 and a connection unit of an optical fiber 310 within the fiber cavity 200.

The distance adjustment part 300 includes a moving unit 330 that is relatively movable with respect to a base 360 and a driving unit 340 for relatively moving the moving unit 330 so that a distance d between a first optical fiber 310 and a second optical fiber 320 that mounts the saturable absorption material 700.

Also, the distance adjustment part 300 includes a coupler 400 branching a laser pulse from a main line to perform a feedback control for stabilizing the laser pulse, a detection unit 500 for extracting monitoring variables of the branched laser pulse, and a driving control unit 600 for substantially adjusting the distance d between the saturable absorption material 700 and the connection unit of the optical fiber 310 on the basis of the monitoring variables.

Also, the distance adjustment part 300 further includes a display unit 800 for allowing a user of the laser system to monitor a distance adjustment state between the saturable absorption material 700 and the connection unit of the optical fiber 310.

FIG. 1 illustrates an example of the distance adjustment part 300 in detail. First, the optical fibers 310 and 320 and the base 360 for supporting the saturable absorption material 700 are disposed within the fiber cavity 200. A fixing unit 350 for maintaining the second optical fibers 320 is supported on the base 360. The saturable absorption material 700 that ultimately realizes mode-locking of the femtosecond laser is supported on an end of the second optical fiber 320 to face the first optical fiber 310. The first optical fiber 310 is horizontally movably supported by the moving part 330 at a relative position of the second optical fiber 320 above the base 360 to face the second optical fiber 320. That is, the first optical fiber 310 relatively moves with respect to the base 360 as the moving unit 330 horizontally moves to change a distance between the saturable absorption material 700 attached to the end of the second optical fiber and the first optical fiber 310. The driving unit 340 for relatively horizontally moving the moving unit 330 supporting the first optical fiber 310 is disposed on the base 360. The driving unit 340 is connected to the driving control unit 600 and thus is controlled by the driving control unit 600.

The coupler 400 splits a portion of an output pulse of the fiber-type femtosecond laser system to transmit the split output pulse into the detection unit 500 for monitoring a signal.

The detection unit 500 includes all of optical detection devices that can be used for detecting light to monitor an output signal. That is, the detection unit 500 may include all of the optical measuring devices such as a spectroscope, a PD, and a power meter. The detection unit 500 detects variations of a spectrum, an intensity of a signal, and a repetition rate as output signals.

In a case where the spectroscope is used as the detection unit 500, when it is determined that a pulse is unstable after monitoring a peak wavelength value, a half width at half maximum, and a shape of a spectrum, the distance d between the saturable absorption material 700 and the connection unit of the optical fiber 310 may be adjusted so that the mode-locking operates for a long time without being broken.

In a case where the PD is used as the detection unit 500, an intensity and frequency of an output signal may be measured to analyze stability of the pulse signal on the basis of variations of the intensity and frequency of the output signal.

The driving control unit 600 includes a controller and program which are needed to control the driving unit 340 provided in the distance adjustment part 300. The driving control unit 600 continuously monitors the monitoring variables such as the peak wavelength value, the half width at half maximum, and the shape of the spectrum which are transmitted from the detection unit 500 to determine a stability state. If an unstable state is detected, the moving unit 330 may horizontally rotates by using the driving unit 340 to adjust the distance d between the saturable absorption material 700 and the connection unit of the optical fiber 310. The driving control unit 600 may further include a separate storage unit (not shown) for storing the monitoring variables in a stable state so as to use when the monitoring variables are compared.

Next, an operation of the apparatus for stabilizing the pulse of the fiber-type femtosecond laser according to the present invention will be described in detail with reference to FIGS. 2 to 4.

In the fiber-type femtosecond laser system using the saturable absorption material 700, when the distance d between the saturable absorption material 700 and the optical fiber 310 corresponds to an optimum distance dm for mode-locking, i.e., d=dm, the laser pulse spectrum may be acquired. However, the pulse spectrum may be completely broken as shown in FIG. 3, or a side peak may gradually occur in the pulse spectrum as shown in FIG. 4 according to changes of external environments as the laser system is used for a long time, an external oscillation due to an impact occurs, the saturable absorption material 700 is deteriorated.

According to analysis of the present applicant, the brokenness phenomenon of the spectrum as shown in FIG. 3 may occur when the distance d between the saturable absorption material 700 and the optical fiber 310 substantially increases. Also, the side peak phenomenon as shown in FIG. 4 may occur when the distance d between the saturable absorption material 700 and the optical fiber 300 substantially decreases. Thus, when the distance d between the saturable absorption material 700 and the optical fiber 310 is adjusted by using the distance adjustment part 300, the femtosecond laser system may be stabilized for a long time. That is, when the brokenness phenomenon of the spectrum as shown in FIG. 3 occurs, the moving unit 330 may move to decrease the distance d, thereby returning to the stable state as shown in FIG. 2. Also, when the side peak phenomenon as shown in FIG. 4 occurs, the moving unit 330 may move to increase the distance d, thereby returning to the stable state as shown in FIG. 2.

Next, a pulse stabilizing apparatus of a fiber-type femtosecond laser according to another embodiment of the present invention will be described with reference to FIG. 5.

FIG. 2 illustrates an apparatus for stabilizing a pulse of a femtosecond laser using a reflective-type saturable absorption material, unlike the transmission-type saturable absorption material as shown in FIG. 1. In this case, a saturable absorption material 700 is attached to a first optical fiber 310, and a plane mirror 370 instead of an optical fiber is attached to a relative position that faces the first optical fiber 310. The plane mirror 370 may be supported on a fixing unit 350 fixed to a base 360.

In another embodiment of the present invention, a driving unit 340 operates according to a control of a driving control unit 600 to rotate a moving unit 330. As a result, the first optical fiber 310 and the saturable absorption material 700 attached to the first optical fiber 310 horizontally move to change a distance d between the saturable absorption material 700 and the plane mirror 370. A mechanism for stabilizing a laser pulse by the above-described operation may be equal to that of the foregoing embodiment described with reference to FIGS. 2 to 4.

Next, an apparatus for stabilizing a pulse of a fiber-type femtosecond laser according to further another embodiment of the present invention will be described with reference to FIG. 6.

A device for driving a piezo 390 as shown in FIG. 6 may be used as the driving unit 340 provided in the distance adjustment part 300 to realize miniaturization and precision operation of a system. The piezo 390 is supported on a base 390 to rotate a driving shaft 380 under the control of a driving control unit 600, thereby horizontally moving a moving unit 330 of a first optical fiber 310. In this case, a distance between a saturable absorption material 700 and the first optical fiber 310 may be controlled in real-time through a fast response speed to restrain a variation of a pulse characteristic due to momentary mechanical oscillation.

Next, a method for stabilizing a pulse of a fiber-type femtosecond laser according to the present invention will be described with reference to FIG. 7.

First, a user for utilizing a fiber-type femtosecond laser system according to the present invention applies a power to utilize the fiber-type femtosecond laser system according to its purpose (S100). When the laser system is initially manufactured, a distance between a saturable absorption material 700 and an optical fiber 310 which are provided within a fiber cavity 200 may be optimally set to realize maximum performance.

In a distance adjustment part 300, a coupler 400 is connected to a main line to split a pulse signal in real-time, thereby continuously transmitting the split pulse signal into a detection unit 500 (S200).

The detection unit 500 extracts monitoring variables for adjusting the distance between the saturable absorption material 700 and the optical fiber 310 by receiving the pulse signal from the coupler 400 (S300). For example, when a peak wavelength value of a spectrum, a half width at half maximum, and a shape of the spectrum are selected as the monitoring variables, the variables are extracted by the detection unit 500. The extracted monitoring variables are transmitted into a driving control unit 600.

Next, the driving control unit 600 determines whether the laser pulse signal is unstable by using the monitoring variables (S400). Since monitoring variables in a stable state are stored in a storage unit (not shown) of the driving control unit 600 so as to compare the monitoring variables in the stable state with the monitoring variables transmitted in real-time, whether laser pulse signal is unstable may be determined in comparison with the monitoring variables in the stable state. Here, whether a generated pulse is unstable as the distance between the saturable absorption material 700 and the optical fiber 310 is widened or as the distance between the saturable absorption material 700 and the optical fiber 310 is narrowed may be determined at the same time (S500).

When it is determined that the laser pulse is unstable, the distance between the saturable absorption material 700 and the optical fiber 310 is adjusted according to the result (S600).

When the distance between the saturable absorption material 700 and the optical fiber 310 is adjusted, the control operation is repeatedly performed until the femtosecond laser returns to an ordinary operational state (S100) thereof to stabilize the laser pulse.

Unlike the related art, in the apparatus and method for stabilizing the pulse of the fiber-type femtosecond layer according to the present invention, the distance between the saturable absorption material 700 and the optical fiber may be automatically adjusted to manufacture the laser system that automatically performs the mode-locking even though the optical pulse is unstable and resists the external oscillation or the external environment variations. In addition, the laser system may be miniaturized and precisely operated to realize the fast response speed, thereby controlling the laser system in real-time and restraining the variation of the pulse characteristic due to the momentary mechanical oscillation.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for stabilizing a pulse of a fiber-type femtosecond laser in a fiber-type femtosecond laser system comprising a pump laser (100) and a fiber cavity (200), the apparatus comprises a distance adjustment part (300) adjusting a distance (d) between a saturable absorption material (700) and a connection unit of an optical fiber (310) which are provided within the fiber cavity (200).

2. The apparatus of claim 1, wherein the distance adjustment part (300) comprises:
a base (360);
a first optical fiber (310);
a second optical fiber (320) that mounts the saturable absorption material (700);
a moving unit (360) supporting the first optical fiber (310) and relatively movable with respect to the base (360) to adjust a distance (d) between the first optical fiber (310) and the saturable absorption material (700) mounted on the second optical fiber (320); and
a driving unit (340) relatively moving the moving unit (330).

3. The apparatus of claim 1, wherein the distance adjustment part (300) comprises:
a coupler (400) branching a laser pulse from a main line to perform a feedback control for stabilizing a laser pulse;
a detection unit (500) for extracting control monitoring variables of the branched laser pulse; and
a driving control unit (600) substantially adjusting the distance (d) between the saturable absorption material (700) and the connection unit of the optical fiber (310) on the basis of the control monitoring variables.

4. The apparatus of claim 1, wherein the distance adjustment part (300) further comprises a display unit (800) allowing a user of the laser system to monitor a distance adjustment state between the saturable absorption material (700) and the connection unit of the optical fiber (310).

5. The apparatus of claim 2, wherein a fixing unit (350) maintaining the second optical fiber (320) is supported on the base (360),
the saturable absorption material (700) is supported on an end of the second optical fiber (320) to face the first optical fiber (310),
the first optical fiber (310) is horizontally movably supported by the moving part (330) at a relative position of the second optical fiber (320) above the base (360) to face the second optical fiber (320), and
the first optical fiber (310) relatively moves with respect to the base (360) as the moving unit (330) of the first optical fiber (310) horizontally moves to change the distance (d) between the saturable absorption material (700) attached to the end of the second optical fiber (320) and the first optical fiber (310).

6. The apparatus of claim 5, wherein the driving unit (340) that is capable of relatively horizontally moving the moving unit (330) supporting the first optical fiber (310) is disposed on the base (360), and
the driving unit (340) is connected to a driving control unit (600) and controlled by the driving control unit (600).

7. The apparatus of claim 3, wherein the detection unit (500) is selected from a spectroscope, a PD, and a power meter as an optical detection device used for detecting light.

8. The apparatus of claim 7, wherein the detection unit (500) detects at least one of variations of a spectrum, an intensity of a signal, and a repetition rate as output signals.

9. The apparatus of claim 7, wherein the detection unit (500) comprises the spectroscope to monitor a peak wavelength value of the laser pulse, a half width at half maximum in a wavelength, and a shape of a spectrum.

10. The apparatus of claim 7, wherein the detection unit (500) comprises the PD to monitor an intensity and frequency of an output signal.

11. The apparatus of claim 3, wherein the driving control unit (600) comprises a storage unit that stores the monitoring variables in a state where the laser pulse is stable.

12. An apparatus for stabilizing a pulse of a fiber-type femtosecond laser in a fiber-type femtosecond laser system comprising a pump laser (100) and a fiber cavity (200) and using a reflective-type saturable absorption material (700), the apparatus comprises a distance adjustment part (300) adjusting a distance (d) between the saturable absorption material (700) and a reflective plane mirror (370) which are provided within the fiber cavity (200).

13. The apparatus of claim 12, wherein the distance adjustment part (300) comprises:
a base (360);
a first optical fiber (310) that mounts the saturable absorption material (700);
the plane mirror (370) disposed on the base (360) to face the saturable absorption material (700);
a moving unit (360) supporting the first optical fiber (310) and relatively movable with respect to the base (360) to adjust a distance (d) between the plane mirror (370) and the saturable absorption material (700) mounted on the first optical fiber (320); and
a driving unit (340) relatively moving the moving unit (330).

14. The apparatus of claim 12, wherein the distance adjustment part (300) comprises:
a coupler (400) branching a laser pulse from a main line to perform a feedback control for stabilizing a laser pulse;
a detection unit (500) for extracting control monitoring variables of the branched laser pulse; and
a driving control unit (600) substantially adjusting the distance (d) between the saturable absorption material (700) and the plane mirror (370) on the basis of the control monitoring variables.

15. The apparatus of claim 12, wherein the distance adjustment part (300) further comprises a display unit (800) allowing a user of the laser system to monitor a distance adjustment state between the saturable absorption material (700) and the plane mirror (370).

16. The apparatus of claim 2, wherein a device for driving a piezo (390) is used as the driving unit (340) adopted for the distance adjustment part (300).

17. The apparatus of claim 16, wherein the piezo (390) comprises a driving shaft (380) and is supported on the base (390) to rotate the driving shaft (380), thereby horizontally moving the moving unit (330).

18. A method for stabilizing a pulse of a fiber-type femtosecond laser, the method comprises:
a first step (S100) of allowing a user of a laser system to apply a power to the laser system to utilize the laser system according to purpose of the laser system;
a second step (S200) of connecting a coupler (400) to a main line to split a pulse signal in real-time, thereby transmitting the split pulse signal into a detection unit (500);
a third step (S300) of receiving the pulse signal into the detection unit (500) from the coupler (400) to extract monitoring variables for adjusting a distance between a saturable absorption material (700) and an optical fiber (310) or a distance between the saturable absorption material (700) or a plane mirror (370);
a fourth step (S400) of determining whether the laser pulse signal is unstable through a driving control unit (600) by using the monitoring variables;
a fifth step (S500) of determining whether the laser pulse signal is unstable as the distance between the saturable absorption material (700) and the optical fiber (310) or the plane mirror (370) is widened or as the distance between the saturable absorption material (700) and the optical fiber (310) or the plane mirror (370) is narrowed;
a sixth step (S600) of adjusting the distance between the saturable absorption material (700) and the optical fiber (310) or the distance between the saturable absorption material (700) or the plane mirror (370) according to the result of the fifth step (S500).

19. The method of claim 18, wherein, in the third step (S300), the detection unit (500) extracts at least one of a peak wavelength value of a spectrum, a half width at half maximum, and a shape of the spectrum as the monitoring variables.

20. The method of claim 18, wherein the fifth step (S500) comprises a step of determining whether the laser pulse signal is unstable by using the monitoring variables previously stored in a stable state.
